(19) United States
(12) Patent Application Publication
(10) Pub. No.: US 2022/0369894 A1
(43) Pub. Date: Nov. 24, 2022

(54) DISH DRYING RACK

(71) Applicant: Chase Moss, Kansas City, MO (US)

(72) Inventor: Chase Moss, Kansas City, MO (US)

(21) Appl. No.: 17/747,027

(22) Filed: May 18, 2022

Related U.S. Application Data
(60) Provisional application No. 63/189,788, filed on May 18, 2021.

(51) Int. Cl. A47L 19/04; A47J 47/16; A47J 47/20

(52) U.S. Cl. CPC A47L 19/04; A47J 47/16; A47J 47/20

(57) ABSTRACT

A dish drying rack includes a base member having a generally flat configuration and construction for catching water falling from drying dishes, the base member having a primary portion and one or more auxiliary portions so that the base member is movable between a retracted configuration and an expanded configuration. The dish drying rack includes a tray container having a plurality of walls extending upwardly from a bottom wall so as to define an interior space suitable for holding drying dishes or small items such as silverware. An auxiliary drying arm is pivotally coupled to an upper edge of an upstanding wall and pivotal between a stored configuration inside the interior area and an extended configuration outside the interior area.

### REFERENCE TO RELATED APPLICATIONS

This application claims the benefit of provisional patent application No. 63/189,788 filed May 18, 2021 and titled Dish Drying Rack, which is incorporated in its entirety.

### BACKGROUND OF THE INVENTION

This invention relates generally to dish drainers and, more particularly, to a dish drying rack that is adjustable, portable, and that has a foldout drying arm.

Most kitchens, whether commercial or residential, have a sink for washing dishes and a drainer or drying rack for holding dishes, cups, glasses, and utensils to air dry after being washed. Even in kitchens having automatic washing machines, there are almost always dishes, pans, and other items to be manually washed and dried. Water drainers are often cumbersome to use and store and often are insufficient in size or configuration to do an acceptable job, especially for larger quantities of dishes, such as in restaurants.

Generally, dish racks are constructed of metal or hard plastic and are positioned on a countertop adjacent a sink or other wash basin. As such, the dish rack is often small and is rarely sufficient to hold the volume of dishes being washed. Dishes invariably get placed on towels spread out on the counter to handle the overflow once the drain rack is full. As a result, water soaks the towels which leads to a mess, odor, and possibly bacteria or mold growth.

Therefore, it would be desirable to have a dish drying rack that has a small footprint for storage or during times of non-use but that may be adjusted to a much larger size during use. Further, it would be desirable to have a dish drying rack having a foldable drying arm that may be pivotally extended during use and that is separate from a washing and drying tray.

### SUMMARY OF THE INVENTION

Therefore, a general object of this invention is to provide a dish drying rack that is adjustable between storage and use configurations.

Another object of this invention is to provide a dish drying rack, as aforesaid, having a dryer arm that is pivotal between a storage configuration inside a tray container and a use configuration extending laterally from the tray container.

Still another object of this invention is to provide a dish drying rack, as aforesaid, having a base that may be expanded both longitudinally and laterally so as to contain water from drying dishes.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a dish drying rack according to a preferred embodiment of the present invention, illustrated a fully retracted configuration;

FIG. 1b is another perspective view of the dish drying rack as in FIG. 1a, illustrated in a fully deployed configuration; and

FIG. 2a is another perspective view of the dish drying rack as in FIG. 1b illustrated in a partially deployed configuration;

FIG. 2b is an isolated view on an enlarged scale taken from FIG. 2a;

FIG. 2c is an isolated view on an enlarged scale taken from FIG. 2a;

FIG. 3a is a bottom perspective view of the dish drying rack as in FIG. 2a; and

FIG. 3b is an isolated view on an enlarged scale taken from FIG. 3a.

### DESCRIPTION OF THE PREFERRED EMBODIMENT

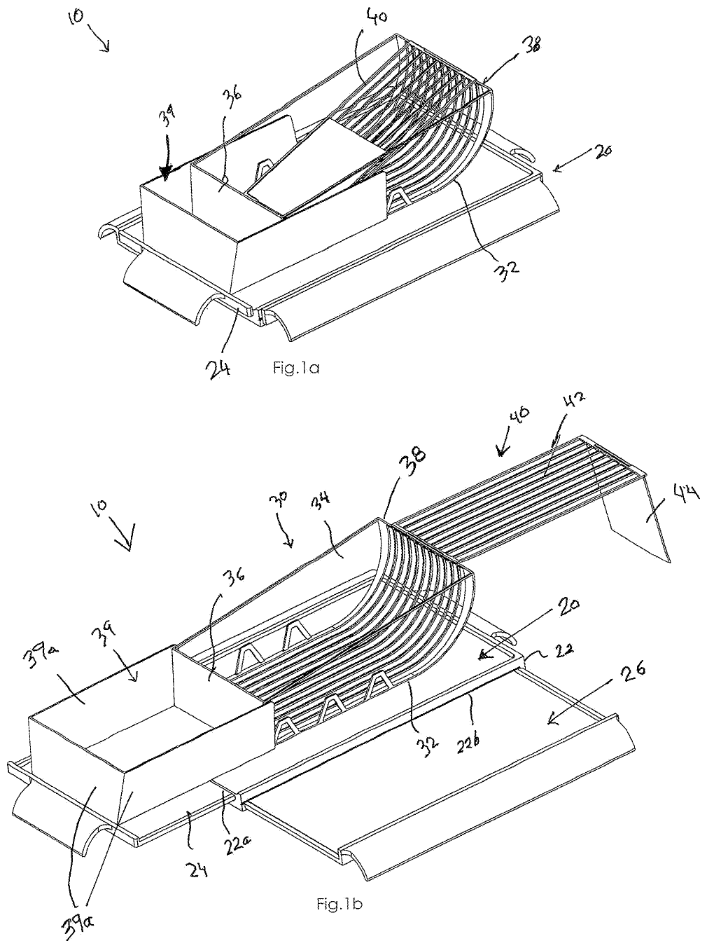

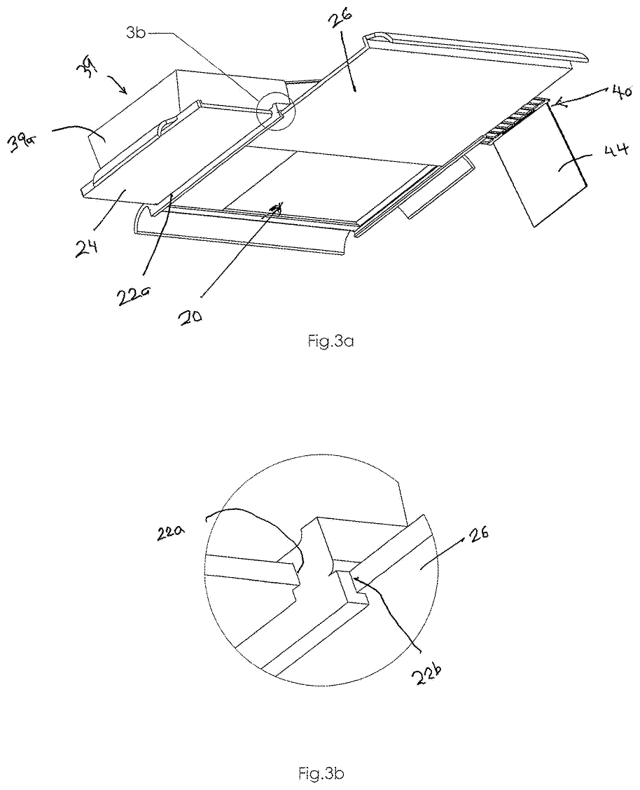

A dish drying rack according to a preferred embodiment of the present invention will now be described with reference to FIG. 1a to 3b of the accompanying drawings. The dish drying rack 10 includes at least a base member 20, a tray container 30, and a drying arm 40. In some embodiments, each of these components may include one or more sub-assemblies such that each component may be expanded or retracted as will be explained below.

The dish drying rack 10 includes a base member 20 having a generally flat configuration for rest upon a countertop surface (not shown) and for supporting the tray container so as to prevent water from the tray container 30 from contacting the countertop surface. The base member 20 and its structure and size adjustments will be described in greater detail later.

Of critical importance, the dish drying rack 10 may include a tray container 30 forming a main basin in which dishes and cups may be stowed while drying. More particularly, the dish drying rack 10 may include a tray container 30 having a bottom wall 32 and a pair of side walls 34 extending upwardly from the bottom wall and spaced apart from one another. In one embodiment, the pair of side walls 34 may include inclined walls such that a downstream area is deeper than an upstream area. Further, the tray container 30 may include a proximal end wall 36 that extends between the pair of side walls 34 and upwardly from the bottom wall 32. Similarly, a distal end wall 38 extends upwardly from the bottom wall 32 and rearwardly opposite the proximal end wall 36. As shown, the bottom wall 32, the pair of side walls 34, the proximal end wall 36, and the distal end wall 38 define an interior area and an open top.

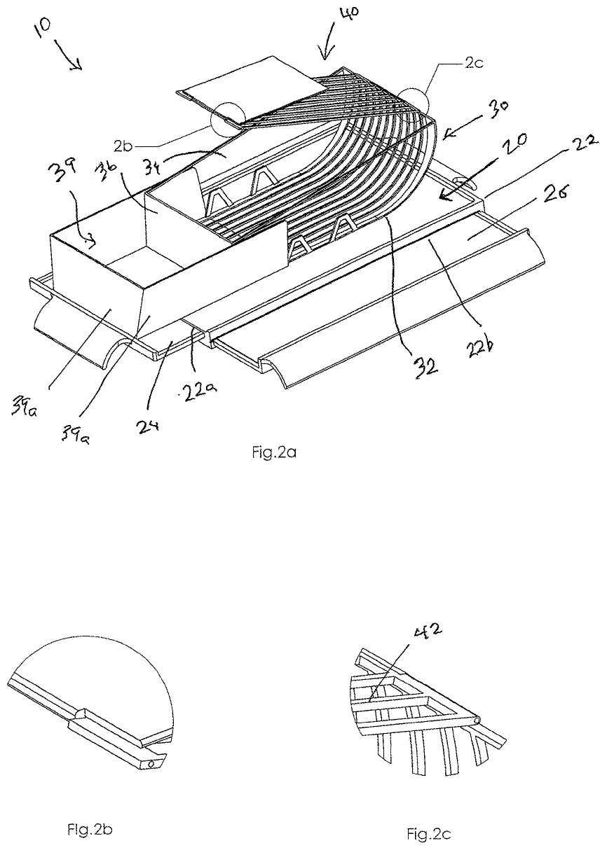

In another aspect, the dish drying rack 10 may include a drying arm 40 that includes a primary wing section 42 having a first end pivotally coupled to a top edge of the distal end wall 38, the drying arm 40 being pivotally movable about a fulcrum defined by the top edge between a storage configuration inside the interior area (FIG. 1a) and a deployed configuration outside the interior area and longitudinally extended away from the tray container (FIG. 1b). Further, the drying arm 40 includes the first end coupled to the top edge and a second end opposite the first end. In an embodiment, the drying arm 40 may include an auxiliary wing section 44 pivotally coupled to the second end of the primary wing section 42 and may have a primary purpose of holding the primary wing section 42 at an extended configuration, such as a level or horizontal configuration (FIG. 1b). In other words, the auxiliary wing section 44 is pivotally movable between a storage configuration folded atop and parallel to the primary wing section 42 (FIG. 2a) and the extended configuration propping up the primary wing section 42 (FIG. 1b)

In an embodiment, the tray container 30 may be longitudinally adjustable or, in other words, is movable between a first configuration having less longitudinal volume for receiving dishes to be dried to a second configuration having more longitudinal volume for receiving dishes. To accomplish this movement, the proximal end wall 36 of the base member 30 is slidably movable forwardly or rearwardly as seen by comparing FIGS. 1a and 1b. In other words, a volume of the interior area of the tray container 30 is increased when the distal end wall 36 is moved forwardly but is decreased when the distal end wall 36 is moved rearwardly.

In a complementary aspect, the tray container 30 may include a drying compartment 39 adjacent the interior area described above. The drying compartment 39 may define a plurality of apertures (not shown) for enhanced air flow as may be useful in drying small items such as utensils, cup lids, or the like. In an embodiment, the drying compartment 39 may include a lower wall and a plurality of upstanding containment panels 39a that, together, define an interior space with an open top. It is understood that end wall 36 is a shared or dividing wall associated with both the drying compartment 39 and tray container 30, the end wall 36 being longitudinally movable as described above and such that movement thereof has an inverse geometric/volumetric effect on the interior space. In other words, a frontward movement of the distal end wall 36 has the effect of decreasing the volume defined by the open space of the drying compartment 39 whereas a rearward movement of the distal end wall 36 increases the volume of the open space of the drying compartment 39.

With reference again to the base member 20, the base member may have a generally planar configuration for rest upon a countertop surface, it being understood that it may have upturned edges that urge water away from the edge. In other words, water may become pooled atop the base member 20.

In another aspect, the base member 20 may be expanded both longitudinally (downstream) and laterally (to the front side). the base member 20 may include a first primary base portion 24 that defines a first channel 22a leading to an interior of the base member 20. The first primary base portion may define a first slot along an end edge of the base number 20 three which the first channel 22a may be accessed. As far Further, the base member 20 may include a first auxiliary base portion 24 slidably coupled to the first primary base portion 22. In other words, the first auxiliary base portion 24 is slidably movable between a first position retracted inside the first primary base portion 22 and a second position longitudinally adjacent the first primary base portion 22 (i.e., the first auxiliary base portion 24 may be extended downstream).

Similarly, a second auxiliary base portion 26 may be slidably coupled to the first primary base portion 22 that defines a second channel 22b leading to an interior of the base member 20. The second primary base portion 26 may define a second slot along a lateral edge of the base number 20 through which the second channel 22b may be accessed. In other words, the second auxiliary base portion 26 may be slidably movable between an unexpanded configuration retracted inside the first primary base portion 22 and an expanded configuration laterally adjacent the first primary base portion 22 (i.e. second auxiliary base portion 26 may be expanded to the front side of the first primary base portion 22).

In use, the dish dryer rack 10 may be used in a residential or commercial environment to increase the efficacy and capacity for drying dishes, cups, glasses, utensils and the like. Now, there is a dish drying rack that is portable and may be stowed in a smaller storage area than ever before.

It is understood that while certain forms of this invention have been illustrated and described, it is not limited thereto except insofar as such limitations are included in the following claims and allowable functional equivalents thereof.

1. A dish drying rack for supporting washed dishware upon a countertop adjacent a sink, comprising:
a base member having a planar configuration for horizontal placement atop of the countertop;
a tray container having a bottom wall supported atop said base member and having a pair of side walls extending upwardly from opposed side edges of said bottom wall, respectively, said tray container having a proximal end wall extending upwardly from said bottom wall and a distal end wall opposite said proximal end wall extending upwardly from said bottom wall,
said bottom wall, said pair of side walls, said proximal end wall, and said distal end wall together defining an interior area and open top;
a drying arm that includes a primary wing section having a first end pivotally coupled to the distal end wall of said tray container and having a second end opposite said first end, said primary wing section being pivotally movable between a stowed configuration positioned in said interior area of said tray container and a deployed configuration extending away from the distal end wall of said tray container.

2. The dish drying rack as in claim 1, wherein said distal end wall of said tray container is longitudinally movable along said pair of side walls between a rearward configuration that decreases a volume of said interior area of said tray container and a forward configuration that increases the volume of said interior area of said tray container.

3. The dish drying rack as in claim 2, further comprising a drying compartment positioned forwardly and longitudinally adjacent said tray container, said drying compartment having a lower wall and a plurality of containment panels extending upwardly from said lower wall so as to define an interior space that is segregated from said interior area by said distal end wall of said tray container.

4. The dish drying rack as in claim 3, wherein a volume defined by said interior space is decreased when said distal end wall is moved toward said forward configuration and is increased when said distal end wall is moved toward said rearward configuration.

5. The dish drying rack as in claim 1, wherein said drying arm includes a secondary wing section pivotally coupled to said second end of said drying arm, and said secondary wing section being pivotally movable between a storage configuration resting atop and parallel to said primary wing section and an extended configuration that is perpendicular to said second end of said drying arm so as to support said drying arm atop the countertop when deployed.

6. The dish drying rack as in claim 1, wherein said base member includes:
a first primary base portion defining a first channel within an interior of said base member and defining a first slot along a end edge of said base member;
a first auxiliary base portion that is slidable between a first retracted position substantially inside the first primary base portion and a first extended position substantially outside and extending through said first slot and away from said first primary base portion.

7. The dish drying rack as in claim 6, wherein said base member includes:
a second primary base portion defining a second channel within an interior of said base member and defining a second slot along a lateral edge of said base member;
a second auxiliary base portion that is slidable between a second retracted position substantially inside the second primary base portion and a second extended position substantially outside and extending through said second slot and away from said second primary base portion.
